(19) United States
(12) Patent Application Publication
(10) Pub. No.: US 2020/0371784 A1
(43) Pub. Date: Nov. 26, 2020

(54) VECTOR FLOATING-POINT SCALE

(71) Applicant: TEXAS INSTRUMENTS INCORPORATED, Dallas, TX (US)

(72) Inventors: Timothy D. ANDERSON, University Park, TX (US); Duc BUI, Grand Prairie, TX (US); Joseph ZBICIAK, San Jose, CA (US)

(21) Appl. No.: 16/422,754

(22) Filed: May 24, 2019

(51) Int. Cl. G06F 9/30

(52) U.S. Cl. CPC G06F 9/3001; G06F 9/30098; G06F 9/30036

(57) ABSTRACT

A method to scale source data in a processor in response to a vector floating-point scale instruction includes specifying a first source register containing the source data, a second source register containing scale values, and a destination register to store scaled source data. The first source register includes a plurality of lanes that each contains a floating-point value and the second source register and the destination register each includes a plurality of lanes corresponding to the lanes of the first source register. The method includes executing the vector floating-point scale instruction by, for each lane in the first source register adding the scale value in the corresponding lane of the second source register to an exponent field of the floating-point value in the lane of the first source register to create a scaled floating-point value, and storing the scaled floating-point value in the corresponding lane of the destination register.

### BACKGROUND

Modern digital signal processors (DSP) face multiple challenges. DSPs may frequently execute software that requires performance of common algorithms that require multiplication or division of a floating-point value by a power of 2 (e.g., Newton-Raphson approximation). A floating-point multiplication operation requires multiple cycles to complete. Considering that DSPs may be frequently to perform algorithms requiring multiplication of a floating-point value by a power of 2, such computational overhead in the form of multiple cycles required to perform each floating-point multiplication operation is not desirable.

### SUMMARY

In accordance with at least one example of the disclosure, a method to scale source data in a processor in response to a vector floating-point scale instruction includes specifying a first source register containing the source data, a second source register containing scale values, and a destination register to store scaled source data. The first source register includes a plurality of lanes that each contains a floating-point value and the second source register and the destination register each includes a plurality of lanes corresponding to the lanes of the first source register. The method includes executing the vector floating-point scale instruction by, for each lane in the first source register adding the scale value in the corresponding lane of the second source register to an exponent field of the floating-point value in the lane of the first source register to create a scaled floating-point value, and storing the scaled floating-point value in the corresponding lane of the destination register.

In accordance with another example of the disclosure, a data processor includes a first source register configured to contain source data, a second source register configured to contain scale values, and a destination register. The first source register includes a plurality of lanes that each contains a floating-point value and the second source register and the destination register each includes a plurality of lanes corresponding to the lanes of the first source register. In response to execution of a single vector floating-point scale instruction, the data processor is configured to, for each lane in the first source register, add the scale value in the corresponding lane of the second source register to an exponent field of the floating-point value in the lane of the first source register to create a scaled floating-point value, and store the scaled floating-point value in the corresponding lane of the destination register.

### BRIEF DESCRIPTION OF THE DRAWINGS

For a detailed description of various examples, reference will now be made to the accompanying drawings in which:

FIG. 1 shows a dual scalar/vector datapath processor in accordance with various examples;

FIG. 2 shows the registers and functional units in the dual scalar/vector datapath processor illustrated in FIG. 1 and in accordance with various examples;

FIG. 3 shows an exemplary global scalar register file;

FIG. 4 shows an exemplary local scalar register file shared by arithmetic functional units;

FIG. 5 shows an exemplary local scalar register file shared by multiply functional units;

FIG. 6 shows an exemplary local scalar register file shared by load/store units;

FIG. 7 shows an exemplary global vector register file;

FIG. 8 shows an exemplary predicate register file;

FIG. 9 shows an exemplary local vector register file shared by arithmetic functional units;

FIG. 10 shows an exemplary local vector register file shared by multiply and correlation functional units;

FIG. 11 shows pipeline phases of the central processing unit in accordance with various examples;

FIG. 12 shows sixteen instructions of a single fetch packet in accordance with various examples;

FIGS. 13A and 13B show exemplary single precision and double precision floating-point values, respectively, in accordance with various examples;

FIGS. 14A and 14B show exemplary sets of registers involved with the execution of instructions in accordance with various examples;

FIGS. 15A and 15B show instruction coding of instructions in accordance with various examples; and

FIG. 16 shows a flow chart of a method of executing instructions in accordance with various examples.

### DETAILED DESCRIPTION

As explained above, DSPs often execute software that requires performance of common algorithms that require multiplication or division of a floating-point value by a power of 2 (e.g., Newton-Raphson approximation). A floating-point multiplication operation requires multiple cycles to complete. Since DSPs may frequently and repetitively perform algorithms requiring multiplication of a floating-point value by a power of 2, such computational overhead in the form of multiple cycles required to perform each floating-point multiplication operation is not desirable.

In order to improve performance of a DSP that performs algorithms requiring multiplication or division of a floating-point value by a power of 2, at least by reducing the computational overhead of such operations, examples of the present disclosure are directed to a vector floating-point scale instruction that scales source data including floating-point values in a first source register and stores the scaled floating-point values in a destination register.

The vector floating-point scale instruction is a single-instruction-multiple-data (SIMD) instruction that operates on data in lanes of the first source register, according to scale values stored in corresponding lanes of a second source register.

For example, the first source register is a 512-bit vector register, and each lane is a 32-bit lane (e.g., a single precision floating-point value). The corresponding lanes of the second source register each contain a scale value. The scale value for each lane may be different, and thus not all lanes need be scaled by the same amount. As a result of executing the vector floating-point scale instruction, each of the 16 scale values of the second source register are applied to one of the 16 single precision floating-point values in the first source register, and the 16 resulting scaled floating-point values are stored in the destination register.

In another example, the source register is a 512-bit vector register, and each lane is a 64-bit lane (e.g., a double precision floating-point value). The corresponding lanes of the second source register each contain a scale value as above. The scale value for each lane may be different, and thus not all lanes need be scaled by the same amount. As a result of executing the vector floating-point scale instruction, each of the 8 scale values of the second source register are applied to one of the 8 double precision floating-point values in the first source register, and the 8 resulting scaled floating-point values are stored in the destination register.

In either of the above examples, the scale value in a corresponding lane of the second source register is applied to the floating-point value in the first source register by adding the scale value to an exponent field of the floating-point value. As will be explained in further detail below, adding to (or subtracting from) the exponent field of a floating-point value has the effect of multiplying (or dividing) the floating-point value by a power of 2. However, unlike conventional, more general floating-point multiplication, which takes several cycles to complete, the vector floating-point scale instruction may be carried out in a single cycle or fewer cycles than a floating-point multiplication operation.

By implementing a single vector floating-point scale instruction that scales floating-point values by powers of 2 and stores the scaled floating-point values, multiplication (or division) of floating-point values by a power of 2 may be carried out with reduced computational overhead. As a result, the overall performance of the DSP is improved when performing algorithms that require multiplication or division of floating-point values by a power of 2.

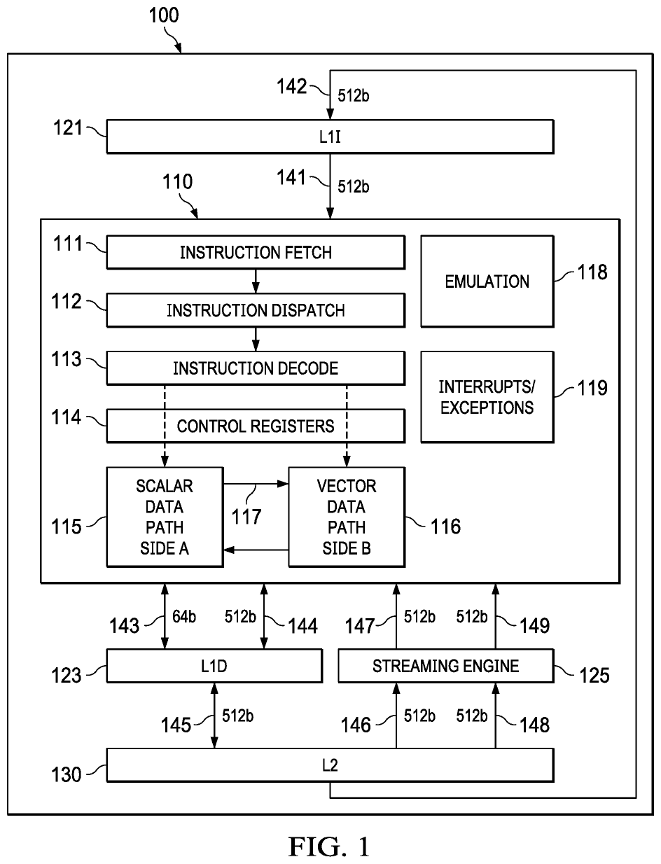

FIG. 1 illustrates a dual scalar/vector datapath processor in accordance with various examples of this disclosure. Processor 100 includes separate level one instruction cache (L1I) 121 and level one data cache (L1D) 123. Processor 100 includes a level two combined instruction/data cache (L2) 130 that holds both instructions and data. FIG. 1 illustrates connection between level one instruction cache 121 and level two combined instruction/data cache 130 (bus 142). FIG. 1 illustrates connection between level one data cache 123 and level two combined instruction/data cache 130 (bus 145). In an example, processor 100 level two combined instruction/data cache 130 stores both instructions to back up level one instruction cache 121 and data to back up level one data cache 123. In this example, level two combined instruction/data cache 130 is further connected to higher level cache and/or main memory in a manner known in the art and not illustrated in FIG. 1. In this example, central processing unit core 110, level one instruction cache 121, level one data cache 123 and level two combined instruction/data cache 130 are formed on a single integrated circuit. This signal integrated circuit optionally includes other circuits.

Central processing unit core 110 fetches instructions from level one instruction cache 121 as controlled by instruction fetch unit 111. Instruction fetch unit 111 determines the next instructions to be executed and recalls a fetch packet sized set of such instructions. The nature and size of fetch packets are further detailed below. As known in the art, instructions are directly fetched from level one instruction cache 121 upon a cache hit (if these instructions are stored in level one instruction cache 121). Upon a cache miss (the specified instruction fetch packet is not stored in level one instruction cache 121), these instructions are sought in level two combined cache 130. In this example, the size of a cache line in level one instruction cache 121 equals the size of a fetch packet. The memory locations of these instructions are either a hit in level two combined cache 130 or a miss. A hit is serviced from level two combined cache 130. A miss is serviced from a higher level of cache (not illustrated) or from main memory (not illustrated). As is known in the art, the requested instruction may be simultaneously supplied to both level one instruction cache 121 and central processing unit core 110 to speed use.

In an example, central processing unit core 110 includes plural functional units to perform instruction specified data processing tasks. Instruction dispatch unit 112 determines the target functional unit of each fetched instruction. In this example, central processing unit 110 operates as a very long instruction word (VLIW) processor capable of operating on plural instructions in corresponding functional units simultaneously. Preferably a complier organizes instructions in execute packets that are executed together. Instruction dispatch unit 112 directs each instruction to its target functional unit. The functional unit assigned to an instruction is completely specified by the instruction produced by a compiler. The hardware of central processing unit core 110 has no part in this functional unit assignment. In this example, instruction dispatch unit 112 may operate on plural instructions in parallel. The number of such parallel instructions is set by the size of the execute packet. This will be further detailed below.

One part of the dispatch task of instruction dispatch unit 112 is determining whether the instruction is to execute on a functional unit in scalar datapath side A 115 or vector datapath side B 116. An instruction bit within each instruction called the s bit determines which datapath the instruction controls. This will be further detailed below.

Instruction decode unit 113 decodes each instruction in a current execute packet. Decoding includes identification of the functional unit performing the instruction, identification of registers used to supply data for the corresponding data processing operation from among possible register files and identification of the register destination of the results of the corresponding data processing operation. As further explained below, instructions may include a constant field in place of one register number operand field. The result of this decoding is signals for control of the target functional unit to perform the data processing operation specified by the corresponding instruction on the specified data.

Central processing unit core 110 includes control registers 114. Control registers 114 store information for control of the functional units in scalar datapath side A 115 and vector datapath side B 116. This information could be mode information or the like.

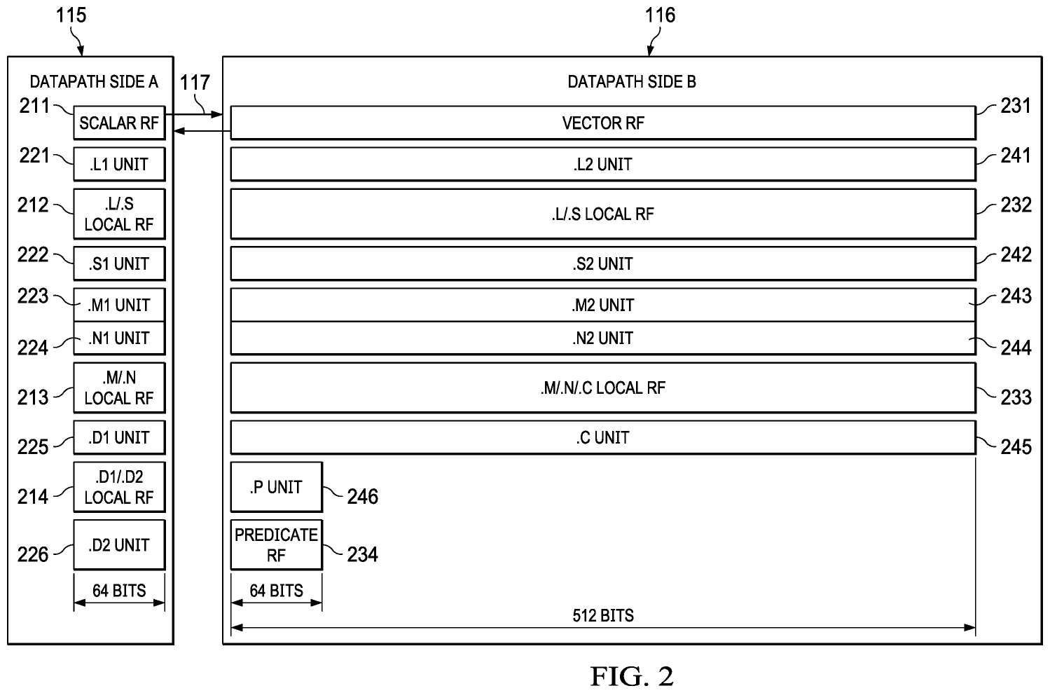

The decoded instructions from instruction decode 113 and information stored in control registers 114 are supplied to scalar datapath side A 115 and vector datapath side B 116. As a result functional units within scalar datapath side A 115 and vector datapath side B 116 perform instruction specified data processing operations upon instruction specified data and store the results in an instruction specified data register or registers. Each of scalar datapath side A 115 and vector datapath side B 116 includes plural functional units that preferably operate in parallel. These will be further detailed below in conjunction with FIG. 2. There is a datapath 117 between scalar datapath side A 115 and vector datapath side B 116 permitting data exchange.

Central processing unit core 110 includes further non-instruction based modules. Emulation unit 118 permits determination of the machine state of central processing unit core 110 in response to instructions. This capability will typically be employed for algorithmic development. Interrupts/exceptions unit 119 enables central processing unit core 110 to be responsive to external, asynchronous events (interrupts) and to respond to attempts to perform improper operations (exceptions).

Central processing unit core 110 includes streaming engine 125. Streaming engine 125 of this illustrated embodiment supplies two data streams from predetermined addresses typically cached in level two combined cache 130 to register files of vector datapath side B 116. This provides controlled data movement from memory (as cached in level two combined cache 130) directly to functional unit operand inputs. This is further detailed below.

FIG. 1 illustrates exemplary data widths of busses between various parts. Level one instruction cache 121 supplies instructions to instruction fetch unit 111 via bus 141. Bus 141 is preferably a 512-bit bus. Bus 141 is unidirectional from level one instruction cache 121 to central processing unit 110. Level two combined cache 130 supplies instructions to level one instruction cache 121 via bus 142. Bus 142 is preferably a 512-bit bus. Bus 142 is unidirectional from level two combined cache 130 to level one instruction cache 121.

Level one data cache 123 exchanges data with register files in scalar datapath side A 115 via bus 143. Bus 143 is preferably a 64-bit bus. Level one data cache 123 exchanges data with register files in vector datapath side B 116 via bus 144. Bus 144 is preferably a 512-bit bus. Busses 143 and 144 are illustrated as bidirectional supporting both central processing unit 110 data reads and data writes. Level one data cache 123 exchanges data with level two combined cache 130 via bus 145. Bus 145 is preferably a 512-bit bus. Bus 145 is illustrated as bidirectional supporting cache service for both central processing unit 110 data reads and data writes.

As known in the art, CPU data requests are directly fetched from level one data cache 123 upon a cache hit (if the requested data is stored in level one data cache 123). Upon a cache miss (the specified data is not stored in level one data cache 123), this data is sought in level two combined cache 130. The memory locations of this requested data is either a hit in level two combined cache 130 or a miss. A hit is serviced from level two combined cache 130. A miss is serviced from another level of cache (not illustrated) or from main memory (not illustrated). As is known in the art, the requested instruction may be simultaneously supplied to both level one data cache 123 and central processing unit core 110 to speed use.

Level two combined cache 130 supplies data of a first data stream to streaming engine 125 via bus 146. Bus 146 is preferably a 512-bit bus. Streaming engine 125 supplies data of this first data stream to functional units of vector datapath side B 116 via bus 147. Bus 147 is preferably a 512-bit bus. Level two combined cache 130 supplies data of a second data stream to streaming engine 125 via bus 148. Bus 148 is preferably a 512-bit bus. Streaming engine 125 supplies data of this second data stream to functional units of vector datapath side B 116 via bus 149. Bus 149 is preferably a 512-bit bus. Busses 146, 147, 148 and 149 are illustrated as unidirectional from level two combined cache 130 to streaming engine 125 and to vector datapath side B 116 in accordance with various examples of this disclosure.

Streaming engine 125 data requests are directly fetched from level two combined cache 130 upon a cache hit (if the requested data is stored in level two combined cache 130). Upon a cache miss (the specified data is not stored in level two combined cache 130), this data is sought from another level of cache (not illustrated) or from main memory (not illustrated). It is technically feasible in some examples for level one data cache 123 to cache data not stored in level two combined cache 130. If such operation is supported, then upon a streaming engine 125 data request that is a miss in level two combined cache 130, level two combined cache 130 should snoop level one data cache 123 for the stream engine 125 requested data. If level one data cache 123 stores this data its snoop response would include the data, which is then supplied to service the streaming engine 125 request. If level one data cache 123 does not store this data its snoop response would indicate this and level two combined cache 130 must service this streaming engine 125 request from another level of cache (not illustrated) or from main memory (not illustrated).

In an example, both level one data cache 123 and level two combined cache 130 may be configured as selected amounts of cache or directly addressable memory in accordance with U.S. Pat. No. 6,606,686 entitled UNIFIED MEMORY SYSTEM ARCHITECTURE INCLUDING CACHE AND DIRECTLY ADDRESSABLE STATIC RANDOM ACCESS MEMORY.

FIG. 2 illustrates further details of functional units and register files within scalar datapath side A 115 and vector datapath side B 116. Scalar datapath side A 115 includes global scalar register file 211, L1/S1 local register file 212, M1/N1 local register file 213 and D1/D2 local register file 214. Scalar datapath side A 115 includes L1 unit 221, S1 unit 222, M1 unit 223, N1 unit 224, D1 unit 225 and D2 unit 226. Vector datapath side B 116 includes global vector register file 231, L2/S2 local register file 232, M2/N2/C local register file 233 and predicate register file 234. Vector datapath side B 116 includes L2 unit 241, S2 unit 242, M2 unit 243, N2 unit 244, C unit 245 and P unit 246. There are limitations upon which functional units may read from or write to which register files. These will be detailed below.

Scalar datapath side A 115 includes L1 unit 221. L1 unit 221 generally accepts two 64-bit operands and produces one 64-bit result. The two operands are each recalled from an instruction specified register in either global scalar register file 211 or L1/S1 local register file 212. L1 unit 221 preferably performs the following instruction selected operations: 64-bit add/subtract operations; 32-bit min/max operations; 8-bit Single Instruction Multiple Data (SIMD) instructions such as sum of absolute value, minimum and maximum determinations; circular min/max operations; and various move operations between register files. The result may be written into an instruction specified register of global scalar register file 211, L1/S1 local register file 212, M1/N1 local register file 213 or D1/D2 local register file 214.

Scalar datapath side A 115 includes S1 unit 222. S1 unit 222 generally accepts two 64-bit operands and produces one 64-bit result. The two operands are each recalled from an instruction specified register in either global scalar register file 211 or L1/S1 local register file 212. S1 unit 222 preferably performs the same type operations as L1 unit 221. There optionally may be slight variations between the data processing operations supported by L1 unit 221 and S1 unit 222. The result may be written into an instruction specified register of global scalar register file 211, L1/S1 local register file 212, M1/N1 local register file 213 or D1/D2 local register file 214.

Scalar datapath side A 115 includes M1 unit 223. M1 unit 223 generally accepts two 64-bit operands and produces one 64-bit result. The two operands are each recalled from an instruction specified register in either global scalar register file 211 or M1/N1 local register file 213. M1 unit 223 preferably performs the following instruction selected operations: 8-bit multiply operations; complex dot product operations; 32-bit bit count operations; complex conjugate multiply operations; and bit-wise Logical Operations, moves, adds and subtracts. The result may be written into an instruction specified register of global scalar register file 211, L1/S1 local register file 212, M1/N1 local register file 213 or D1/D2 local register file 214.

Scalar datapath side A 115 includes N1 unit 224. N1 unit 224 generally accepts two 64-bit operands and produces one 64-bit result. The two operands are each recalled from an instruction specified register in either global scalar register file 211 or M1/N1 local register file 213. N1 unit 224 preferably performs the same type operations as M1 unit 223. There may be certain double operations (called dual issued instructions) that employ both the M1 unit 223 and the N1 unit 224 together. The result may be written into an instruction specified register of global scalar register file 211, L1/S1 local register file 212, M1/N1 local register file 213 or D1/D2 local register file 214.

Scalar datapath side A 115 includes D1 unit 225 and D2 unit 226. D1 unit 225 and D2 unit 226 generally each accept two 64-bit operands and each produce one 64-bit result. D1 unit 225 and D2 unit 226 generally perform address calculations and corresponding load and store operations. D1 unit 225 is used for scalar loads and stores of 64 bits. D2 unit 226 is used for vector loads and stores of 512 bits. D1 unit 225 and D2 unit 226 preferably also perform: swapping, pack and unpack on the load and store data; 64-bit SIMD arithmetic operations; and 64-bit bit-wise logical operations. D1/D2 local register file 214 will generally store base and offset addresses used in address calculations for the corresponding loads and stores. The two operands are each recalled from an instruction specified register in either global scalar register file 211 or D1/D2 local register file 214. The calculated result may be written into an instruction specified register of global scalar register file 211, L1/S1 local register file 212, M1/N1 local register file 213 or D1/D2 local register file 214.

Vector datapath side B 116 includes L2 unit 241. L2 unit 241 generally accepts two 512-bit operands and produces one 512-bit result. The two operands are each recalled from an instruction specified register in either global vector register file 231, L2/S2 local register file 232 or predicate register file 234. L2 unit 241 preferably performs instruction similar to L1 unit 221 except on wider 512-bit data. The result may be written into an instruction specified register of global vector register file 231, L2/S2 local register file 232, M2/N2/C local register file 233 or predicate register file 234.

Vector datapath side B 116 includes S2 unit 242. S2 unit 242 generally accepts two 512-bit operands and produces one 512-bit result. The two operands are each recalled from an instruction specified register in either global vector register file 231, L2/S2 local register file 232 or predicate register file 234. S2 unit 242 preferably performs instructions similar to S1 unit 222. The result may be written into an instruction specified register of global vector register file 231, L2/S2 local register file 232, M2/N2/C local register file 233 or predicate register file 234.

Vector datapath side B 116 includes M2 unit 243. M2 unit 243 generally accepts two 512-bit operands and produces one 512-bit result. The two operands are each recalled from an instruction specified register in either global vector register file 231 or M2/N2/C local register file 233. M2 unit 243 preferably performs instructions similar to M1 unit 223 except on wider 512-bit data. The result may be written into an instruction specified register of global vector register file 231, L2/S2 local register file 232 or M2/N2/C local register file 233.

Vector datapath side B 116 includes N2 unit 244. N2 unit 244 generally accepts two 512-bit operands and produces one 512-bit result. The two operands are each recalled from an instruction specified register in either global vector register file 231 or M2/N2/C local register file 233. N2 unit 244 preferably performs the same type operations as M2 unit 243. There may be certain double operations (called dual issued instructions) that employ both M2 unit 243 and the N2 unit 244 together. The result may be written into an instruction specified register of global vector register file 231, L2/S2 local register file 232 or M2/N2/C local register file 233.

Vector datapath side B 116 includes C unit 245. C unit 245 generally accepts two 512-bit operands and produces one 512-bit result. The two operands are each recalled from an instruction specified register in either global vector register file 231 or M2/N2/C local register file 233. C unit 245 preferably performs: “Rake” and “Search” instructions; up to 512 2-bit PN*8-bit multiplies I/Q complex multiplies per clock cycle; 8-bit and 16-bit Sum-of-Absolute-Difference (SAD) calculations, up to 512 SADs per clock cycle; horizontal add and horizontal min/max instructions; and vector permutes instructions. C unit 245 also contains 4 vector control registers (CUCR0 to CUCR3) used to control certain operations of C unit 245 instructions. Control registers CUCR0 to CUCR3 are used as operands in certain C unit 245 operations. Control registers CUCR0 to CUCR3 are preferably used: in control of a general permutation instruction (VPERM); and as masks for SIMD multiple DOT product operations (DOTPM) and SIMD multiple Sum-of-Absolute-Difference (SAD) operations. Control register CUCR0 is preferably used to store the polynomials for Galois Field Multiply operations (GFMPY). Control register CUCR1 is preferably used to store the Galois field polynomial generator function.

Vector datapath side B 116 includes P unit 246. P unit 246 performs basic logic operations on registers of local predicate register file 234. P unit 246 has direct access to read from and write to predication register file 234. These operations include single register unary operations such as: NEG (negate) which inverts each bit of the single register; BITCNT (bit count) which returns a count of the number of bits in the single register having a predetermined digital state (1 or 0); RMBD (right most bit detect) which returns a number of bit positions from the least significant bit position (right most) to a first bit position having a predetermined digital state (1 or 0); DECIMATE which selects every instruction specified Nth (1, 2, 4, etc.) bit to output; and EXPAND which replicates each bit an instruction specified N times (2, 4, etc.). These operations include two register binary operations such as: AND a bitwise AND of data of the two registers; NAND a bitwise AND and negate of data of the two registers; OR a bitwise OR of data of the two registers; NOR a bitwise OR and negate of data of the two registers; and XOR exclusive OR of data of the two registers. These operations include transfer of data from a predicate register of predicate register file 234 to another specified predicate register or to a specified data register in global vector register file 231. A commonly expected use of P unit 246 includes manipulation of the SIMD vector comparison results for use in control of a further SIMD vector operation. The BITCNT instruction may be used to count the number of 1's in a predicate register to determine the number of valid data elements from a predicate register.

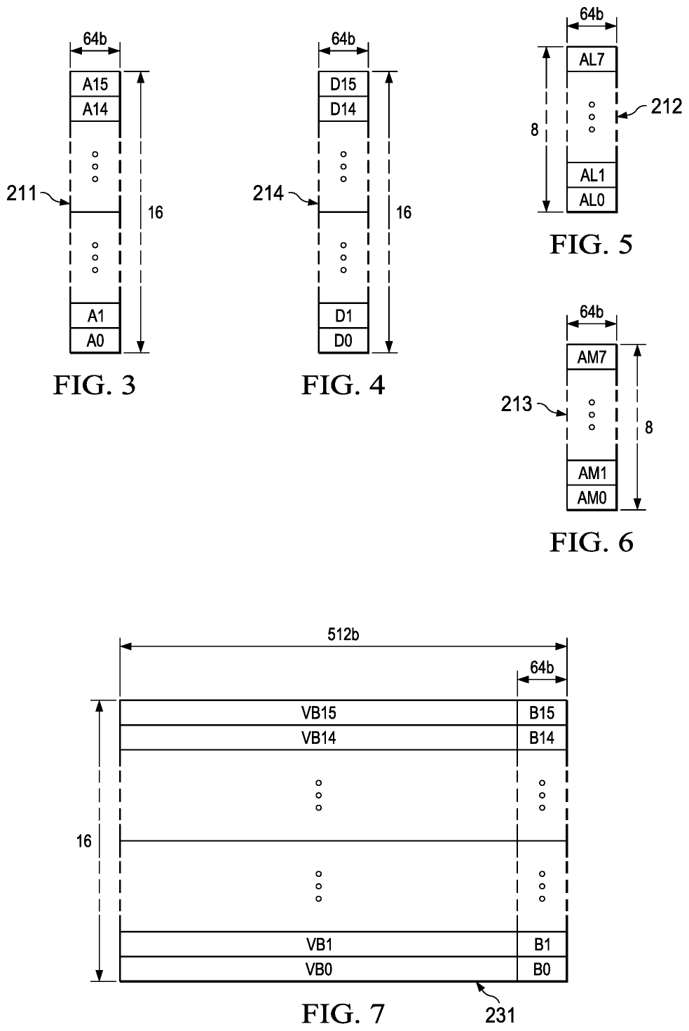

FIG. 3 illustrates global scalar register file 211. There are 16 independent 64-bit wide scalar registers designated A0 to A15. Each register of global scalar register file 211 can be read from or written to as 64-bits of scalar data. All scalar datapath side A 115 functional units (L1 unit 221, S1 unit 222, M1 unit 223, N1 unit 224, D1 unit 225 and D2 unit 226) can read or write to global scalar register file 211. Global scalar register file 211 may be read as 32-bits or as 64-bits and may only be written to as 64-bits. The instruction executing determines the read data size. Vector datapath side B 116 functional units (L2 unit 241, S2 unit 242, M2 unit 243, N2 unit 244, C unit 245 and P unit 246) can read from global scalar register file 211 via crosspath 117 under restrictions that will be detailed below.

FIG. 4 illustrates D1/D2 local register file 214. There are 16 independent 64-bit wide scalar registers designated D0 to D16. Each register of D1/D2 local register file 214 can be read from or written to as 64-bits of scalar data. All scalar datapath side A 115 functional units (L1 unit 221, S1 unit 222, M1 unit 223, N1 unit 224, D1 unit 225 and D2 unit 226) can write to global scalar register file 211. Only D1 unit 225 and D2 unit 226 can read from D1/D2 local scalar register file 214. It is expected that data stored in D1/D2 local scalar register file 214 will include base addresses and offset addresses used in address calculation.

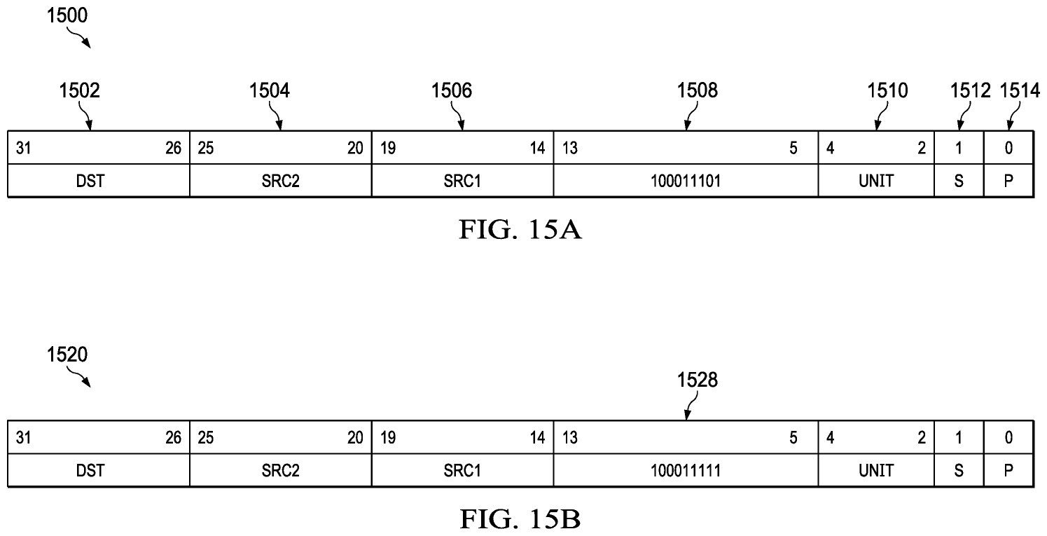

FIG. 5 illustrates L1/S1 local register file 212. The example illustrated in FIG. 5 has 8 independent 64-bit wide scalar registers designated AL0 to AL7. The preferred instruction coding (see FIG. 15) permits L1/S1 local register file 212 to include up to 16 registers. The example of FIG. 5 implements only 8 registers to reduce circuit size and complexity. Each register of L1/S1 local register file 212 can be read from or written to as 64-bits of scalar data. All scalar datapath side A 115 functional units (L1 unit 221, S1 unit 222, M1 unit 223, N1 unit 224, D1 unit 225 and D2 unit 226) can write to L1/S1 local scalar register file 212. Only L1 unit 221 and S1 unit 222 can read from L1/S1 local scalar register file 212.

FIG. 6 illustrates M1/N1 local register file 213. The example illustrated in FIG. 6 has 8 independent 64-bit wide scalar registers designated AM0 to AM7. The preferred instruction coding (see FIG. 15) permits M1/N1 local register file 213 to include up to 16 registers. The example of FIG. 6 implements only 8 registers to reduce circuit size and complexity. Each register of M1/N1 local register file 213 can be read from or written to as 64-bits of scalar data. All scalar datapath side A 115 functional units (L1 unit 221, S1 unit 222, M1 unit 223, N1 unit 224, D1 unit 225 and D2 unit 226) can write to M1/N1 local scalar register file 213. Only M1 unit 223 and N1 unit 224 can read from M1/N1 local scalar register file 213.

FIG. 7 illustrates global vector register file 231. There are 16 independent 512-bit wide vector registers. Each register of global vector register file 231 can be read from or written to as 64-bits of scalar data designated B0 to B15. Each register of global vector register file 231 can be read from or written to as 512-bits of vector data designated VB0 to VB15. The instruction type determines the data size. All vector datapath side B 116 functional units (L2 unit 241, S2 unit 242, M2 unit 243, N2 unit 244, C unit 245 and P unit 246) can read or write to global scalar register file 231. Scalar datapath side A 115 functional units (L1 unit 221, S1 unit 222, M1 unit 223, N1 unit 224, D1 unit 225 and D2 unit 226) can read from global vector register file 231 via crosspath 117 under restrictions that will be detailed below.

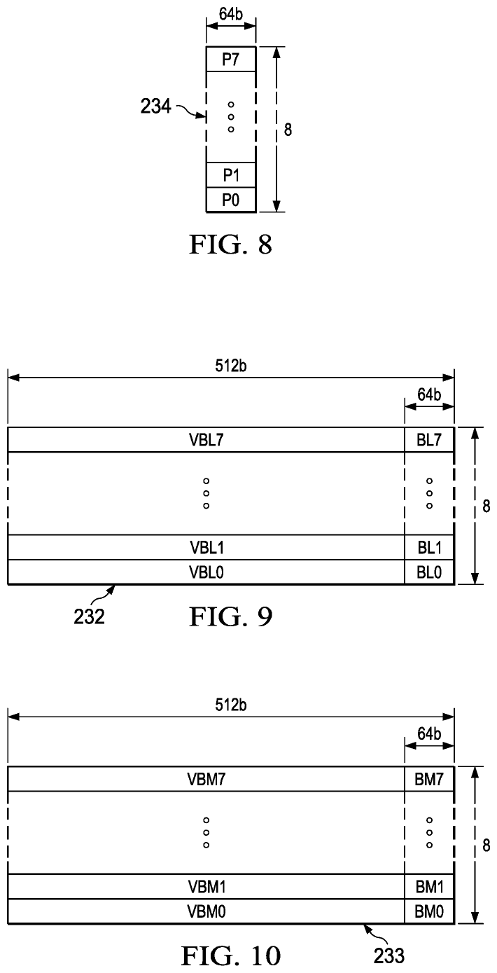

FIG. 8 illustrates P local register file 234. There are 8 independent 64-bit wide registers designated P0 to P7. Each register of P local register file 234 can be read from or written to as 64-bits of scalar data. Vector datapath side B 116 functional units L2 unit 241, S2 unit 242, C unit 244 and P unit 246 can write to P local register file 234. Only L2 unit 241, S2 unit 242 and P unit 246 can read from P local scalar register file 234. A commonly expected use of P local register file 234 includes: writing one bit SIMD vector comparison results from L2 unit 241, S2 unit 242 or C unit 244; manipulation of the SIMD vector comparison results by P unit 246; and use of the manipulated results in control of a further SIMD vector operation.

FIG. 9 illustrates L2/S2 local register file 232. The example illustrated in FIG. 9 has 8 independent 512-bit wide vector registers. The preferred instruction coding (see FIG. 15) permits L2/S2 local register file 232 to include up to 16 registers. The example of FIG. 9 implements only 8 registers to reduce circuit size and complexity. Each register of L2/S2 local vector register file 232 can be read from or written to as 64-bits of scalar data designated BL0 to BL7. Each register of L2/S2 local vector register file 232 can be read from or written to as 512-bits of vector data designated VBL0 to VBL7. The instruction type determines the data size. All vector datapath side B 116 functional units (L2 unit 241, S2 unit 242, M2 unit 243, N2 unit 244, C unit 245 and P unit 246) can write to L2/S2 local vector register file 232. Only L2 unit 241 and S2 unit 242 can read from L2/S2 local vector register file 232.

FIG. 10 illustrates M2/N2/C local register file 233. The example illustrated in FIG. 10 has 8 independent 512-bit wide vector registers. The preferred instruction coding (see FIG. 15) permits M2/N2/C local vector register file 233 include up to 16 registers. The example of FIG. 10 implements only 8 registers to reduce circuit size and complexity. Each register of M2/N2/C local vector register file 233 can be read from or written to as 64-bits of scalar data designated BM0 to BM7. Each register of M2/N2/C local vector register file 233 can be read from or written to as 512-bits of vector data designated VBM0 to VBM7. All vector datapath side B 116 functional units (L2 unit 241, S2 unit 242, M2 unit 243, N2 unit 244, C unit 245 and P unit 246) can write to M2/N2/C local vector register file 233. Only M2 unit 243, N2 unit 244 and C unit 245 can read from M2/N2/C local vector register file 233.

The provision of global register files accessible by all functional units of a side and local register files accessible by only some of the functional units of a side is a design choice. Some examples of this disclosure employ only one type of register file corresponding to the disclosed global register files.

Referring back to FIG. 2, crosspath 117 permits limited exchange of data between scalar datapath side A 115 and vector datapath side B 116. During each operational cycle one 64-bit data word can be recalled from global scalar register file A 211 for use as an operand by one or more functional units of vector datapath side B 116 and one 64-bit data word can be recalled from global vector register file 231 for use as an operand by one or more functional units of scalar datapath side A 115. Any scalar datapath side A 115 functional unit (L1 unit 221, S1 unit 222, M1 unit 223, N1 unit 224, D1 unit 225 and D2 unit 226) may read a 64-bit operand from global vector register file 231. This 64-bit operand is the least significant bits of the 512-bit data in the accessed register of global vector register file 231. Plural scalar datapath side A 115 functional units may employ the same 64-bit crosspath data as an operand during the same operational cycle. However, only one 64-bit operand is transferred from vector datapath side B 116 to scalar datapath side A 115 in any single operational cycle. Any vector datapath side B 116 functional unit (L2 unit 241, S2 unit 242, M2 unit 243, N2 unit 244, C unit 245 and P unit 246) may read a 64-bit operand from global scalar register file 211. If the corresponding instruction is a scalar instruction, the crosspath operand data is treated as any other 64-bit operand. If the corresponding instruction is a vector instruction, the upper 448 bits of the operand are zero filled. Plural vector datapath side B 116 functional units may employ the same 64-bit crosspath data as an operand during the same operational cycle. Only one 64-bit operand is transferred from scalar datapath side A 115 to vector datapath side B 116 in any single operational cycle.

Streaming engine 125 transfers data in certain restricted circumstances. Streaming engine 125 controls two data streams. A stream consists of a sequence of elements of a particular type. Programs that operate on streams read the data sequentially, operating on each element in turn. Every stream has the following basic properties. The stream data have a well-defined beginning and ending in time. The stream data have fixed element size and type throughout the stream. The stream data have a fixed sequence of elements. Thus, programs cannot seek randomly within the stream. The stream data is read-only while active. Programs cannot write to a stream while simultaneously reading from it. Once a stream is opened, the streaming engine 125: calculates the address; fetches the defined data type from level two unified cache (which may require cache service from a higher level memory); performs data type manipulation such as zero extension, sign extension, data element sorting/swapping such as matrix transposition; and delivers the data directly to the programmed data register file within CPU 110. Streaming engine 125 is thus useful for real-time digital filtering operations on well-behaved data. Streaming engine 125 frees these memory fetch tasks from the corresponding CPU enabling other processing functions.

Streaming engine 125 provides the following benefits. Streaming engine 125 permits multi-dimensional memory accesses. Streaming engine 125 increases the available bandwidth to the functional units. Streaming engine 125 minimizes the number of cache miss stalls since the stream buffer bypasses level one data cache 123. Streaming engine 125 reduces the number of scalar operations required to maintain a loop. Streaming engine 125 manages address pointers. Streaming engine 125 handles address generation automatically freeing up the address generation instruction slots and D1 unit 225 and D2 unit 226 for other computations.

CPU 110 operates on an instruction pipeline. Instructions are fetched in instruction packets of fixed length further described below. All instructions require the same number of pipeline phases for fetch and decode, but require a varying number of execute phases.

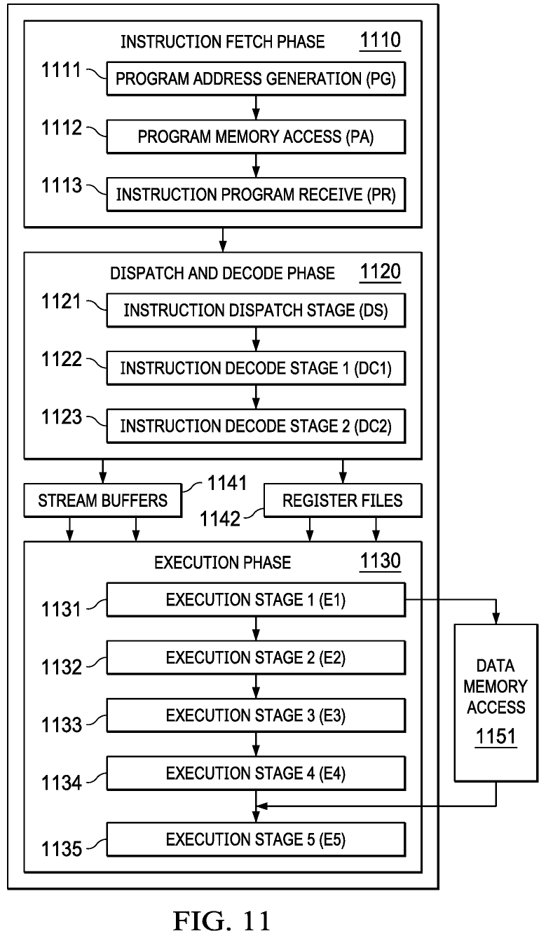

FIG. 11 illustrates the following pipeline phases: program fetch phase 1110, dispatch and decode phases 1120 and execution phases 1130. Program fetch phase 1110 includes three stages for all instructions. Dispatch and decode phases 1120 include three stages for all instructions. Execution phase 1130 includes one to four stages dependent on the instruction.

Fetch phase 1110 includes program address generation stage 1111 (PG), program access stage 1112 (PA) and program receive stage 1113 (PR). During program address generation stage 1111 (PG), the program address is generated in the CPU and the read request is sent to the memory controller for the level one instruction cache L1I. During the program access stage 1112 (PA) the level one instruction cache L1I processes the request, accesses the data in its memory and sends a fetch packet to the CPU boundary. During the program receive stage 1113 (PR) the CPU registers the fetch packet.

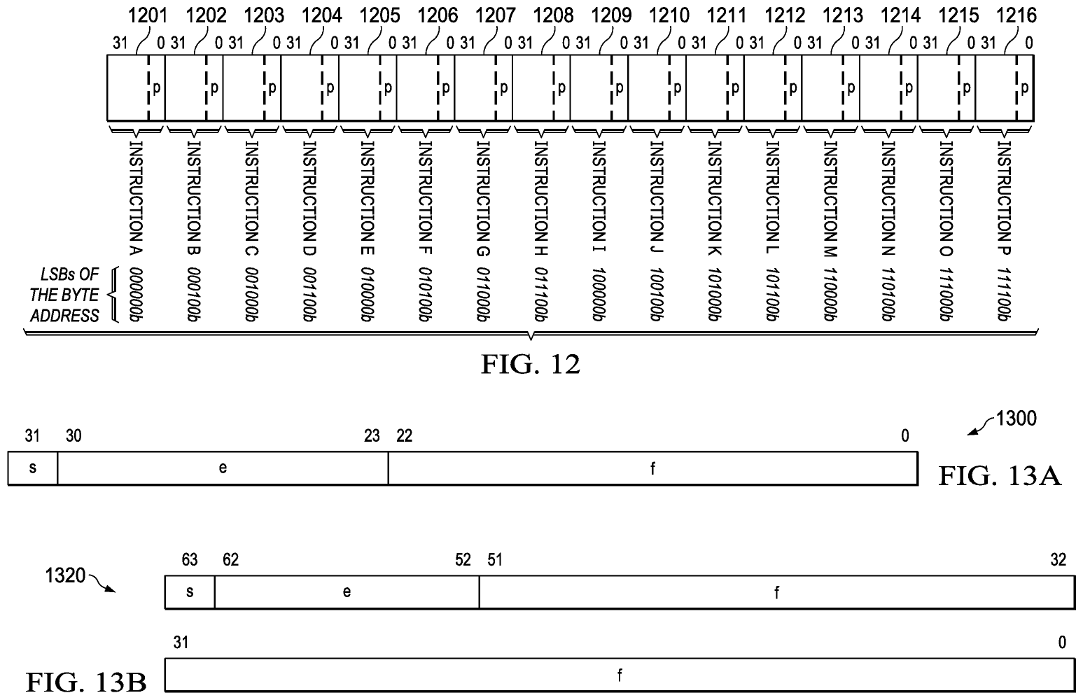

Instructions are always fetched sixteen 32-bit wide slots, constituting a fetch packet, at a time. FIG. 12 illustrates 16 instructions 1201 to 1216 of a single fetch packet. Fetch packets are aligned on 512-bit (16-word) boundaries. An example employs a fixed 32-bit instruction length. Fixed length instructions are advantageous for several reasons. Fixed length instructions enable easy decoder alignment. A properly aligned instruction fetch can load plural instructions into parallel instruction decoders. Such a properly aligned instruction fetch can be achieved by predetermined instruction alignment when stored in memory (fetch packets aligned on 512-bit boundaries) coupled with a fixed instruction packet fetch. An aligned instruction fetch permits operation of parallel decoders on instruction-sized fetched bits. Variable length instructions require an initial step of locating each instruction boundary before they can be decoded. A fixed length instruction set generally permits more regular layout of instruction fields. This simplifies the construction of each decoder which is an advantage for a wide issue VLIW central processor.

The execution of the individual instructions is partially controlled by a p bit in each instruction. This p bit is preferably bit 0 of the 32-bit wide slot. The p bit determines whether an instruction executes in parallel with a next instruction. Instructions are scanned from lower to higher address. If the p bit of an instruction is 1, then the next following instruction (higher memory address) is executed in parallel with (in the same cycle as) that instruction. If the p bit of an instruction is 0, then the next following instruction is executed in the cycle after the instruction.

CPU 110 and level one instruction cache L1I 121 pipelines are de-coupled from each other. Fetch packet returns from level one instruction cache L1I can take different number of clock cycles, depending on external circumstances such as whether there is a hit in level one instruction cache 121 or a hit in level two combined cache 130. Therefore program access stage 1112 (PA) can take several clock cycles instead of 1 clock cycle as in the other stages.

The instructions executing in parallel constitute an execute packet. In an example, an execute packet can contain up to sixteen instructions. No two instructions in an execute packet may use the same functional unit. A slot is one of five types: 1) a self-contained instruction executed on one of the functional units of CPU 110 (L1 unit 221, S1 unit 222, M1 unit 223, N1 unit 224, D1 unit 225, D2 unit 226, L2 unit 241, S2 unit 242, M2 unit 243, N2 unit 244, C unit 245 and P unit 246); 2) a unitless instruction such as a NOP (no operation) instruction or multiple NOP instruction; 3) a branch instruction; 4) a constant field extension; and 5) a conditional code extension. Some of these slot types will be further explained below.

Dispatch and decode phases 1120 include instruction dispatch to appropriate execution unit stage 1121 (DS), instruction pre-decode stage 1122 (DC1); and instruction decode, operand reads stage 1123 (DC2). During instruction dispatch to appropriate execution unit stage 1121 (DS), the fetch packets are split into execute packets and assigned to the appropriate functional units. During the instruction pre-decode stage 1122 (DC1), the source registers, destination registers and associated paths are decoded for the execution of the instructions in the functional units. During the instruction decode, operand reads stage 1123 (DC2), more detailed unit decodes are done, as well as reading operands from the register files.

Execution phases 1130 includes execution stages 1131 to 1135 (E1 to E5). Different types of instructions require different numbers of these stages to complete their execution. These stages of the pipeline play an important role in understanding the device state at CPU cycle boundaries.

During execute 1 stage 1131 (E1) the conditions for the instructions are evaluated and operands are operated on. As illustrated in FIG. 11, execute 1 stage 1131 may receive operands from a stream buffer 1141 and one of the register files shown schematically as 1142. For load and store instructions, address generation is performed and address modifications are written to a register file. For branch instructions, branch fetch packet in PG phase is affected. As illustrated in FIG. 11, load and store instructions access memory here shown schematically as memory 1151. For single-cycle instructions, results are written to a destination register file. This assumes that any conditions for the instructions are evaluated as true. If a condition is evaluated as false, the instruction does not write any results or have any pipeline operation after execute 1 stage 1131.

During execute 2 stage 1132 (E2) load instructions send the address to memory. Store instructions send the address and data to memory. Single-cycle instructions that saturate results set the SAT bit in the control status register (CSR) if saturation occurs. For 2-cycle instructions, results are written to a destination register file.

During execute 3 stage 1133 (E3) data memory accesses are performed. Any multiply instructions that saturate results set the SAT bit in the control status register (CSR) if saturation occurs. For 3-cycle instructions, results are written to a destination register file.

During execute 4 stage 1134 (E4) load instructions bring data to the CPU boundary. For 4-cycle instructions, results are written to a destination register file.

During execute 5 stage 1135 (E5) load instructions write data into a register. This is illustrated schematically in FIG. 11 with input from memory 1151 to execute 5 stage 1135.

In some cases, the processor 100 (e.g., a DSP) may be called upon to execute software that requires performance of common algorithms that require multiplication or division of a floating-point value by a power of 2 (e.g., Newton-Raphson approximation). A floating-point multiplication operation requires multiple cycles to complete. Since DSPs may frequently and repetitively perform algorithms requiring multiplication of a floating-point value by a power of 2, such computational overhead in the form of multiple cycles required to perform each floating-point multiplication operation is not desirable.

Floating-point operands are classified as single precision (e.g., 32-bit values) and double precision (e.g., 64-bit values). IEEE floating-point numbers may be classified as a zero value, a normal value, a subnormal value, an infinite value, and a NaN value. NaN values may be either a quiet NaN (QNaN) or a signaling NaN (SNaN). Subnormal values are nonzero values that are smaller than the smallest nonzero normal value. Infinity is a value that represents an infinite floating-point number. NaN values represent results for invalid operations, such as (+infinity+(−infinity)). Normal single precision values are accurate to at least six decimal places, sometimes up to nine decimal places. Normal double precision values are accurate to at least 15 decimal places, sometimes up to 17 decimal places.

FIG. 13A shows an example coding of a single precision floating-point value 1300. The single precision floating-point value 1300 comprises 32 bits as explained above. Bit 31 is a sign bit (s) (e.g., 0 is a positive value, 1 is a negative value). Bits 23 to 30 are an 8-bit exponent field (e). Bits 0 to 22 are a 23-bit fraction field (f). The fields of the floating-point value 1300 represent floating-point values within two ranges: normal (0<e<255) and subnormal (e=0). The following formulas define how to translate the sign, exponent, and fraction fields into a single precision floating-point value.

Normal: −1^{s}×2^{(e-127)}×1.f, where 0<e<255;

Subnormal: −1^{s}×2⁻¹²⁶×0.f, where e=0 and f is nonzero.

FIG. 13B shows an example coding of a double precision floating-point value 1320. The double precision floating-point value 1320 comprises 64 bits as explained above. Bit 63 is a sign bit (s) (e.g., 0 is a positive value, 1 is a negative value). Bits 52 to 62 are an 11-bit exponent field (e). Bits 0 to 51 are a 52-bit fraction field (f). Similar to the single precision floating-point value 1300, the fields of the floating-point value 1320 represent floating-point values within two ranges: normal (0<e<2047) and subnormal (e=0). The following formulas define how to translate the sign, exponent, and fraction fields into a double precision floating-point value.

Normal: −1^{s}×2^{(e-1023)}×1.f, where 0<e<2047;

Subnormal: −1^{s}×2⁻¹⁰²²×0.f, where e=0 and f is nonzero.

Referring back to the single precision floating-point value 1300 of FIG. 13A, this value 1300 may also be one of a number of special values, demonstrated by the following Table 1.1:

TABLE 1.1
Special Single Precision Values

| Symbol | Sign (s) | Exponent (e) | Fraction (f) |
|---|---|---|---|
| +0 | 0 | 0 | 0 |
| −0 | 1 | 0 | 0 |
| +Inf | 0 | 255 | 0 |
| −Inf | 1 | 255 | 0 |
| NaN | x | 255 | nonzero |
| QNaN | x | 255 | 1xx . . . x |
| SNaN | x | 255 | 0xx . . . x and nonzero |

As demonstrated in Table 1.1, zero values include both +/−zero, which differs only in the sign bit of the floating-point value 1300. Similarly, infinity values include both +/−infinity, which differs only in the sign bit of the floating-point value 1300. Further, a NaN value is generalized (e.g., fraction field is nonzero) while a QNaN value (e.g., fraction field equal to 1xx . . . x) and a SNaN value (e.g., fraction field equal to 0xx . . . x, but not zero) are more specific versions of the generalized NaN classification. The sign bit is not considered for classification of a floating-point value as a NaN value.

Referring back to the double precision floating-point value 1320 of FIG. 13B, this value 1320 may also be one of a number of special values, demonstrated by the following Table 1.2:

TABLE 1.2
Special Double Precision Values

| Symbol | Sign (s) | Exponent (e) | Fraction (f) |
|---|---|---|---|
| +0 | 0 | 0 | 0 |
| −0 | 1 | 0 | 0 |
| +Inf | 0 | 2047 | 0 |
| −Inf | 1 | 2047 | 0 |
| NaN | x | 2047 | nonzero |
| QNaN | x | 2047 | 1xx . . . x |
| SNaN | x | 2047 | 0xx . . . x and nonzero |

As demonstrated in Table 1.2, zero values include both +/−zero, which differs only in the sign bit of the floating-point value 1320. Similarly, infinity values include both +/−infinity, which differs only in the sign bit of the floating-point value 1320. Further, a NaN value is generalized (e.g., fraction field is nonzero) while a QNaN value (e.g., fraction field equal to 1xx . . . x) and a SNaN value (e.g., fraction field equal to 0xx . . . x, but not zero) are more specific versions of the generalized NaN classification. The sign bit is not considered for classification of a floating-point value as a NaN value.

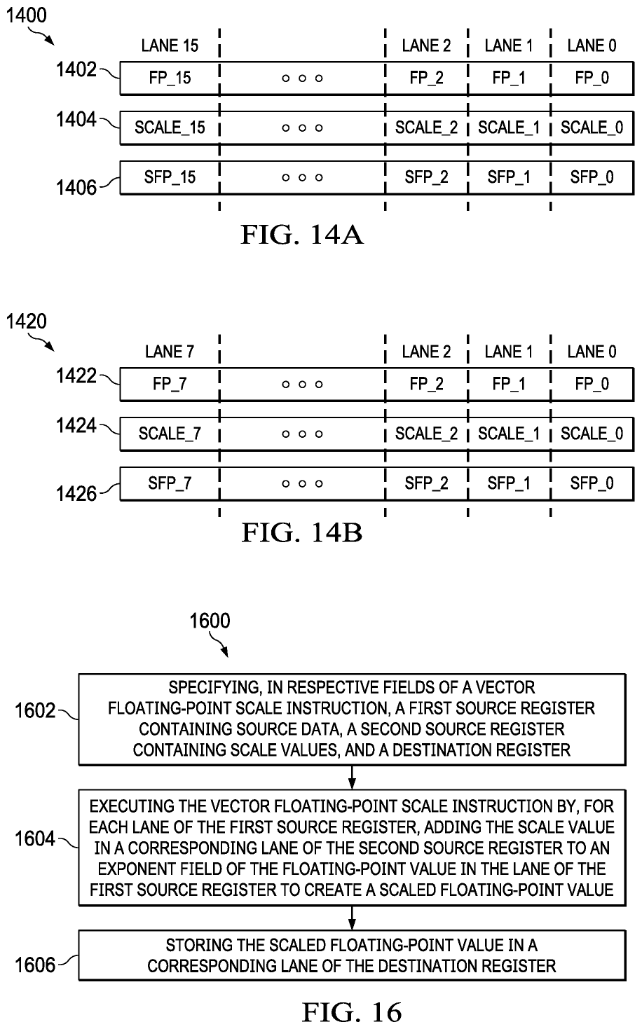

FIG. 14A illustrates an example of registers 1400 utilized in executing a vector floating-point scale instruction for single precision floating-point values (e.g., each floating-point value is 32 bits). The registers 1400 include a first source register 1402, a second source register 1404, and a destination register 1406. In this example, the first and second source registers 1402, 1404 and the destination register 1406 are 512-bit vector registers such as those contained in the global vector register file 231 explained above. However, in other examples, any of the first and second source registers 1402, 1404 and the destination register 1406 may also be of a different sizes; the scope of this disclosure is not limited to a particular register size or set of register sizes.

In this example where the floating-point values to be scaled are single precision (e.g., 32 bits or a single word), the first and second source registers 1402, 1404 and the destination register 1404 are divided into 16 equal-sized lanes labeled Lane 0 through Lane 15. Each lane of the first source register 1402 contains a single precision floating-point value, labeled FP_0 through FP_15. Each lane of the second source register 1404 contains a scale value, labeled SCALE_0 through SCALE_15. In one example, the scale values are 16-bit values and the remaining bits of each lane (e.g., the uppermost 16 bits) are ignored. The scale values may be treated as signed values, allowing for multiplication or division by a power of 2 (e.g., by adding to or subtracting from the exponent field of the corresponding floating-point value in the first source register 1402). The scale values may also be treated as unsigned values. Each lane of the destination register 1406 contains a scaled floating-point value that results from adding the scale value in the corresponding lane of the second source register 1404 to an exponent field of the floating-point value in the corresponding lane of the first source register 1402. The scaled floating-point values in the destination register 1406 are labeled SFP_0 through SFP_15. Data that is in a like-numbered lane in different registers is said to be in a “corresponding” lane. For example, FP_0 of the first source register 1402, SCALE_0 of the second source register 1404, and SFP_0 of the destination register 1406 are in a corresponding lane, namely Lane 0.

FIG. 14B illustrates an example of registers 1420 utilized in executing a vector floating-point scale instruction for double precision floating-point values (e.g., each floating-point value is 64 bits). The registers 1420 include a first source register 1422, a second source register 1424, and a destination register 1426. In this example, the first and second source registers 1422, 1424 and the destination register 1426 are 512-bit vector registers such as those contained in the global vector register file 231 explained above. However, in other examples, the first and second source registers 1422, 1424 and the destination register 1426 may also be of a different sizes; the scope of this disclosure is not limited to a particular register size or set of register sizes.

In this example where the floating-point values to be scaled are double precision (e.g., 64 bits or a double word), the first and second source registers 1422, 1424 and the destination register 1424 are divided into 8 equal-sized lanes labeled Lane 0 through Lane 7. Each lane of the first source register 1422 contains a double precision floating-point value, labeled FP_0 through FP_7. Each lane of the second source register 1424 contains a scale value, labeled SCALE_0 through SCALE_7. In one example, the scale values are 16-bit values and the remaining bits of each lane (e.g., the uppermost 48 bits) are ignored. The scale values may be treated as signed values, allowing for multiplication or division by a power of 2 (e.g., by adding to or subtracting from the exponent field of the corresponding floating-point value in the first source register 1422). The scale values may also be treated as unsigned values. Each lane of the destination register 1426 contains a scaled floating-point value that results from adding the scale value in the corresponding lane of the second source register 1424 to an exponent field of the floating-point value in the corresponding lane of the first source register 1422. The scaled floating-point values in the destination register 1426 are labeled SFP_0 through SFP_7. Data that is in a like-numbered lane in different registers is said to be in a “corresponding” lane. For example, FP_0 of the first source register 1422, SCALE_0 of the second source register 1424, and SFP_0 of the destination register 1426 are in a corresponding lane, namely Lane 0.

A vector floating-point scale instruction contains fields that specify the first and second source registers 1402/1422, 1404/1424 and the destination register 1406/1426 (e.g., in the global vector register file 231). The vector floating-point scale instruction also contains a field (e.g., an opcode field, which will be explained further below) that specifies whether floating-point values are single precision or double precision (e.g., lane size of the registers 1400, 1420).

In response to executing the vector floating-point scale instruction, the DSP 100 adds the scale value in each lane of the second source register 1404/1424 to an exponent field of the floating-point value in the corresponding lane of the first source register 1402/1422 to scale the floating-point value, resulting in a scaled floating-point value. The DSP 100 stores the scaled floating-point values in a corresponding lane of the destination register 1406/1426.

The following examples are provided to illustrate the functionality of the vector floating-point scale instruction. The examples are in reference to FIG. 14A, in which the floating-point values are single precision values. However, it should be appreciated that for the purposes of applying the disclosed vector floating-point scale instruction, the difference between single precision and double precision floating-point values is simply in the range of values contained in the exponent field.

In a first example, referring to Lane 0 of the registers 1400, a floating-point value (e.g., FP_0) is given by 2^{(e-127)}×1.f, as explained above. In this example, f is variable for generalit y and e=128. Thus, FP_0=2⁽¹²⁸⁻¹²⁷⁾×1.f=2×1.f. The corresponding scale value, SCALE_0, is equal to 2, which denotes desired scaling of the floating-point value FP_0 of by a factor of 4 (e.g., 2^{SCALE_0}). As explained above, in response to executing the vector floating-point scale instruction, the DSP 100 adds the scale value in each lane of the second source register 14004 to an exponent field of the floating-point value in the corresponding lane of the first source register 1402. Thus, in response to executing the vector floating-point scale instruction, SCALE_0 is added to e of FP_0, resulting in a scaled floating-point value SFP_0 having e=128+2=130, and the scaled floating-point value SFP_0 being equal to 2⁽¹³⁰⁻¹²⁷⁾×1.f=2⁽³⁾×1.f=8×1.f, 4 times greater than the floating-point value FP_0 stored in the first source register 1402. The scaled floating-point value SFP_0 is stored in the corresponding lane of the destination register 1406.

In a second example, referring to Lane 0 of the registers 1400, a floating-point value (e.g., FP_0) is given by 2^{(e-127)}×1.f, as explained above. In this example, f is variable for generality and e=128. Thus, FP_0=2⁽¹²⁸⁻¹²⁷⁾×1..f=2×1.f. The corresponding scale value, SCALE_0, is equal to −2, which denotes desired scaling of the floating-point value FP_0 of by a factor of ¼ (e.g., 2^{SCALE_0}). As explained above, in response to executing the vector floating-point scale instruction, the DSP 100 adds the scale value in each lane of the second source register 1404 to an exponent field of the floating-point value in the corresponding lane of the first source register 1402. Thus, in response to executing the vector floating-point scale instruction, SCALE_0 is added to e of FP_0, resulting in a scaled floating-point value SFP_0 having e=128−2=126, and the scaled floating-point value SFP_0 being equal to 2⁽¹²⁶⁻¹²⁷⁾×1.f=2^{(31 1)}×1.f=½×1.f, which is ¼ the floating-point value FP_0 stored in the first source register 1402. The scaled floating-point value SFP_0 is stored in the corresponding lane of the destination register 1406.

The above discussion generally addresses scaling of normal floating-point values. However, certain examples of the vector floating-point scale instruction are also operable on subnormal and special floating-point values, explained above. For example, if the floating-point value in the first source register 1402 is a smallest normal floating-point value and the scale value in the corresponding lane of the second source register 1404 scales the floating-point value down into the subnormal range, a denormalization shift is performed, which shifts the fraction rightward and exposes the otherwise-hidden ‘1’, while clamping the exponent at 0. Similarly, if the floating-point value in the first source register 1402 is a largest subnormal floating-point value and the scale value in the corresponding lane of the second source register 1404 scales the floating-point value up into the normal range, a normalization shift is performed to normalize the fraction field and the ‘1’ portion of the fraction field is hidden. Additionally, it is determined what portion of the scale value is consumed by normalization of the fraction field and the remaining portion of the scale value is then applied to the exponent field of the scaled floating-point value.

In still other examples, if the scale value in the corresponding lane of the second source register 1404, when applied to the floating-point value in the first source register 1402, scales the floating-point value down (in absolute value) below a smallest normal floating-point value (either positive or negative), a flush-to-zero mode is employed in which the scaled floating-point value is a zero value, rather than a subnormal value as described above. In yet other examples, if the scale value in the corresponding lane of the second source register 1404, when applied to the floating-point value in the first source register 1402, scales the floating-point value up (in absolute value) above a largest normal floating-point value (either positive or negative), the scaled floating-point value in the destination register 1406 is a +/−infinity value.

In another example, the first source register 1402 includes one or more special floating-point values, such as +/−zero, +/−infinity, or NaNs. In this example, execution of the vector floating-point scale instruction also checks for various conditions before adding a scale value to the exponent field of the floating-point value. For example, if the floating-point value in the first source register 1402 is +/−zero, then regardless of the scale value in the corresponding lane of the second source register 1404, the scaled result in the corresponding lane of the destination register 1406 will remain +/−zero. Similarly, if the floating-point value in the first source register 1402 is +/−infinity, then regardless of the scale value in the corresponding lane of the second source register 1404, the scaled result in the corresponding lane of the destination register 1406 will remain +/−infinity.

In further examples, execution of the vector floating-point scale instruction updates floating-point status registers as if a floating-point multiply had been carried out, for example to handle NaN cases.

FIG. 15A illustrates an example of the instruction coding 1500 of functional unit instructions used by examples of this disclosure. Those skilled in the art would realize that other instruction codings are feasible and within the scope of this disclosure. Each instruction consists of 32 bits and controls the operation of one of the individually controllable functional units (L1 unit 221, S1 unit 222, M1 unit 223, N1 unit 224, D1 unit 225, D2 unit 226, L2 unit 241, S2 unit 242, M2 unit 243, N2 unit 244, C unit 245 and P unit 246). The bit fields are defined as follows.

The dst field 1502 (bits 26 to 31) specifies a destination register in a corresponding vector register file 231 that contains the results (e.g., scaled floating-point values) of execution of the vector floating-point scale instruction (e.g., a 512-bit vector in one example).

The src2 field 1504 (bits 20 to 25) specifies a second source register, which includes scale values that are, in the example of FIG. 15A, 16-bit signed values. As explained above, depending on the size of the second source register and the number of lanes, the uppermost bits of each lane in excess of 16 bits are ignored.

The src1 field 1506 (bits 14 to 19) specifies a first source register, which includes floating-point values that are, in the example of FIG. 15A, single precision floating-point values that are to be scaled according to the above description, creating scaled floating-point values that are stored in the destination register.

The opcode field 1508 (bits 5 to 13) designates appropriate instruction options (e.g., whether lanes of the source data are single precision floating-point values (32 bits) or double precision floating-point values (64 bits)). For example, the opcode field 1508 of FIG. 15A corresponds to scaling single precision floating-point values, for example as shown in FIG. 14A. FIG. 15B illustrates instruction coding 1520 that is identical to that shown in FIG. 15A, except that the instruction coding 1520 includes an opcode field 1528 that corresponds to scaling double precision floating-point values, for example as shown in FIG. 14B. The unit field 1510 (bits 2 to 4) provides an unambiguous designation of the functional unit used and operation performed, which in this case is the L1 unit 221 or the S1 unit 222. A detailed explanation of the opcode is generally beyond the scope of this disclosure except for the instruction options detailed above.

The s bit 1510 (bit 1) designates scalar datapath side A 115 or vector datapath side B 116. If s=0, then scalar datapath side A 115 is selected. This limits the functional unit to L1 unit 221, S1 unit 222, M1 unit 223, N1 unit 224, D1 unit 225 and D2 unit 226 and the corresponding register files illustrated in FIG. 2. Similarly, s=1 selects vector datapath side B 116 limiting the functional unit to L2 unit 241, S2 unit 242, M2 unit 243, N2 unit 244, P unit 246 and the corresponding register file illustrated in FIG. 2.

The p bit 1512 (bit 0) marks the execute packets. The p-bit determines whether the instruction executes in parallel with the following instruction. The p-bits are scanned from lower to higher address. If p=1 for the current instruction, then the next instruction executes in parallel with the current instruction. If p=0 for the current instruction, then the next instruction executes in the cycle after the current instruction. All instructions executing in parallel constitute an execute packet. An execute packet can contain up to twelve instructions. Each instruction in an execute packet must use a different functional unit.

FIG. 16 shows a flow chart of a method 1600 in accordance with examples of this disclosure. The method 1600 begins in block 1602 with specifying a first source register containing source data, a second source register containing scale values, and a destination register. The first and second source registers and the destination register are specified in fields of a vector floating-point scale instruction, such as the src1 field 1506, the src2 field 1504, and the dst field 1502, respectively, which are described above with respect to FIG. 15. The source data may be a 512-bit vector in which floating-point values are either single precision floating-point values or double-precision floating point values. Further, the scale values may be 16-bit values that are either signed values or unsigned values.

The method 1600 continues in block 1604 with executing the vector floating-point scale instruction, in particular by, for each lane of the first source register, adding the scale value in the corresponding lane of the second source register to an exponent field of the floating-point value in the lane of the first source register. As explained above, depending on whether the scale value is signed, the scale value can also subtract from the exponent field of the floating-point value. Regardless, application of the scale value to the exponent field of the floating-point value results in a scaled floating-point value. As explained above, the scale value applied to each floating-point value need not be the same, and thus the floating-point value in a first lane of the first source register may be scaled by a first amount, while a floating-point value in a second lane of the first source register may be scaled by a second, different amount. The method 1600 continues in block 1606 with storing the scaled floating-point value in a corresponding lane of the destination register.

Block 1604 of the method 1600 generally addresses scaling of normal floating-point values in response to execution of a vector floating-point scale instruction. However, as described above, certain other examples of the vector floating-point scale instruction are also operable on subnormal and special floating-point values (e.g., +/−zero, +/−infinity, and NaNs). For example, scaling a floating-point value down in absolute value below a smallest (either positive or negative) normal floating-point value may result in performing a denormalization shift to shift the fraction field of the floating-point value rightward, exposing the otherwise-hidden ‘1’, and clamping the exponent field at 0. Similarly, scaling a floating-point value up in absolute value above a largest subnormal floating-point value (either positive or negative) may result in performing a normalization shift to normalize the fraction field and hide the ‘1’ portion of the fraction field. Additionally, it is determined what portion of the scale value is consumed by normalization of the fraction field and the remaining portion of the scale value is then applied to the exponent field of the scaled floating-point value.

In still other examples, if the scale value in the corresponding lane of the second source register 1404, when applied to the floating-point value in the first source register 1402, scales the floating-point value down (in absolute value) below a smallest normal floating-point value (either positive or negative), a flush-to-zero mode is employed in which the scaled floating-point value is a zero value, rather than a subnormal value as described above. In yet other examples, if the scale value in the corresponding lane of the second source register 1404, when applied to the floating-point value in the first source register 1402, scales the floating-point value up (in absolute value) above a largest normal floating-point value (either positive or negative), the scaled floating-point value in the destination register 1406 is a +/−infinity value.

In another example, the floating-point value includes one or more special floating-point values, such as +/−zero, +/−infinity, or NaNs. In this example, execution of the vector floating-point scale instruction also checks for various conditions before adding a scale value to the exponent field of the floating-point value. For example, if the floating-point value in the first source register 1402 is +/−zero, then regardless of the scale value in the corresponding lane of the second source register 1404, the scaled result in the corresponding lane of the destination register 1406 will remain +/−zero. Similarly, if the floating-point value in the first source register 1402 is +/−infinity, then regardless of the scale value in the corresponding lane of the second source register 1404, the scaled result in the corresponding lane of the destination register 1406 will remain +/−infinity.

In the foregoing discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections. Similarly, a device that is coupled between a first component or location and a second component or location may be through a direct connection or through an indirect connection via other devices and connections. An element or feature that is “configured to” perform a task or function may be configured (e.g., programmed or structurally designed) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. Additionally, uses of the phrases “ground” or similar in the foregoing discussion are intended to include a chassis ground, an Earth ground, a floating ground, a virtual ground, a digital ground, a common ground, and/or any other form of ground connection applicable to, or suitable for, the teachings of the present disclosure. Unless otherwise stated, “about,” “approximately,” or “substantially” preceding a value means +/−10 percent of the stated value.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method to scale source data in a processor in response to a vector floating-point scale instruction, the method comprising:
specifying, in respective fields of the vector floating-point scale instruction, a first source register containing the source data, a second source register containing scale values, and a destination register to store scaled source data, wherein the first source register comprises a plurality of lanes that each contains a floating-point value and the second source register and the destination register each comprises a plurality of lanes corresponding to the lanes of the first source register; and
executing the vector floating-point scale instruction, wherein executing the vector floating-point scale instruction further comprises, for each lane in the first source register:
adding the scale value in the corresponding lane of the second source register to an exponent field of the floating-point value in the lane of the first source register to create a scaled floating-point value; and
storing the scaled floating-point value in the corresponding lane of the destination register.

2. The method of claim 1, wherein the source data comprises a 512-bit vector.

3. The method of claim 1, wherein each floating-point value comprises a single precision floating-point value.

4. The method of claim 1, wherein each floating-point value comprises a double precision floating-point value.

5. The method of claim 1, wherein the scale values comprise 16-bit values.

6. The method of claim 1, wherein the scale values are signed values.

7. The method of claim 1, wherein the scale values are unsigned values.

8. The method of claim 1, wherein at least one of the scale values is different than others of the scale values.

9. The method of claim 1, wherein the floating-point value in one lane of the first source register comprises a plus or minus zero floating-point value and executing the vector floating-point scale instruction further comprises:
storing a plus or minus zero floating-point value, respectively, in the lane of the destination register corresponding to the one lane regardless of the scale value in the lane of the second source register corresponding to the one lane.

10. The method of claim 1, wherein the floating-point value in one lane of the first source register comprises a plus or minus infinity floating-point value and executing the vector floating-point scale instruction further comprises:
storing a plus or minus infinity floating-point value, respectively, in the lane of the destination register corresponding to the one lane regardless of the scale value in the lane of the second source register corresponding to the one lane.

11. The method of claim 1, wherein the scale value in a lane of the second source register, when applied to the floating-point value in a corresponding lane of the first source register scales the floating-point value down below a smallest normal floating-point value , wherein executing the vector floating-point scale instruction further comprises:
denormalizing a fraction field of the floating-point value in the one lane; and
clamping the exponent field of the floating-point value in the one lane to 0 to create the scaled floating-point value.

12. The method of claim 1, wherein the scale value in a lane of the second source register, when applied to the floating-point value in a corresponding lane of the first source register scales the floating-point value up above a largest subnormal floating-point value, wherein executing the vector floating-point scale instruction further comprises:
normalizing a fraction field of the floating-point value in the one lane;
determining a portion of the scale value that is consumed by normalizing the fraction field; and
applying a remaining portion of the scale value to the exponent field of the floating-point value in the one lane to create the scaled floating-point value.

13. A data processor, comprising:
a first source register configured to contain source data;
a second source register configured to contain scale values; and
a destination register;
wherein the first source register comprises a plurality of lanes that each contains a floating-point value and the second source register and the destination register each comprises a plurality of lanes corresponding to the lanes of the first source register;
wherein, in response to execution of a single vector floating-point scale instruction, the data processor is configured to, for each lane in the first source register:
add the scale value in the corresponding lane of the second source register to an exponent field of the floating-point value in the lane of the first source register to create a scaled floating-point value; and
store the scaled floating-point value in the corresponding lane of the destination register.

14. The data processor of claim 13, wherein the source data comprises a 512-bit vector.

15. The data processor of claim 13, wherein each floating-point value comprises a single precision floating-point value.

16. The data processor of claim 13, wherein each floating-point value comprises a double precision floating-point value.

17. The data processor of claim 13, wherein the scale values comprise 16-bit values.

18. The data processor of claim 13, wherein the scale values are signed values.

19. The data processor of claim 13, wherein the scale values are unsigned values.

20. The data processor of claim 13, wherein at least one of the scale values is different than others of the scale values.
